(19) United States
(12) Patent Application Publication
(10) Pub. No.: US 2003/0182151 A1
(43) Pub. Date: Sep. 25, 2003

(54) Method of using biometric measurements as a legal seal for authenticating real estate deeds and mortgages

(76) Inventor: Neal Taslitz, Wellington, FL (US)

Correspondence Address: Milton S. Gerstein, 6629 N. Francisco Avenue, Chicago, IL, 60645, US

(21) Appl. No.: 10/374,703

(22) Filed: Feb. 25, 2003

Related U.S. Application Data
(60) Provisional application No. 60/359,574, filed on Feb. 26, 2002.

(51) Int. Cl. G06F 17/60

(52) U.S. Cl. 705/1

(57) ABSTRACT

A method of providing an electronic seal to a real estate deed, mortgage or land trust document using a biometric measurement of the original signer to the document, which biometric measurement is stored in a central computer for access at a future date when such document is presented for transaction. The software of the system of the invention generates an authorization code or number representative of the stored unique biometric measurement, which code is then physically placed on, or inserted into, the document evidencing the biometric seal of the user. The correlating code is unique to the document and the stored biometric seal therefor. The unique biometric measurement is “married” to the legal document to provide a “legal seal” and obviate the use of mechanical, waxed, embossed or printed seals. This biometric seal provides the guarantee to the financial institution or other party in the legal transaction that the person who has signed the document and provided a biometric measurement is indeed the actual person that he or she claims to be.

### CROSS REFERENCE TO RELATED APPLICATION

Priority of provisional application serial No. 60/359,574 filed on Feb. 26, 2002 is herewith claimed,

### BACKGROUND OF THE INVENTION

The present invention is directed to the area of the prevention of fraud in real estate transactions, and, in particular, to the detection of fraudulent identities with respect to deeds, mortgages and land trust documents, such fraud having become an ever-increasing problem to banks and title companies. Land trust documents are an important part of real estate transactions in many states. If real estate is held in a land trust, the deed is in the name of the trustee, not the individual owner of the property. A real estate deed, mortgage or land trust document, after having been executed, is typically stored for many years until needed. When such documents are presented, it is necessary to ensure that the person presenting the document, or purporting to be the signer on the document, is the very same individual signed on the original document. Typically, title companies and banks have used the signature on the documents and supporting papers presented for establishing proper identity between the presenter and the signature on the document, which method, although adequate in the majority of transactions, has still allowed a large amount of fraudulent transactions to occur by persons who are not the actual signers to the original documents. In addition, there has, also, been the problem of finding an adequate, convenient, relatively inexpensive and very secure method of providing a legal seal for real estate and mortgage documents or deeds, since providing such a legal seal on the deed or document, as compared to signatures only, extends the statute of limitations on the document in those states that extend the statutes of limitations on documents containing seals. Such seals are used to both authenticate and guarantee the identity of the individual signing the document, which authentication and guarantee may be only required many years after the legal sealing thereof.

There is now currently available biometric-measurements technology that uses unique, identifying personal characteristics of a person, in order to ensure security and secure accessing to sensitive and private areas, networks, and the like. Biometric measuring devices identify a person using one or more of the following unique and qualifying characteristics: Electronic fingerprint recognition, hand geometry recognition, voice recognition, retina, iris, and facial scans, and other similar uniquely defining characteristics of the person. An example of using biometric measurements for securing the resources of an enterprise, is disclosed in U.S. Pat. No. 6,256,737—Bianco, et al., which patent is incorporated by reference herein, which patent discloses a system and method of protecting access to network resources, such as a LAN, WAN, and the like, using biometric measurements.

### SUMMARY OF THE INVENTION

It is, therefore, the primary objective of the present invention to provide a method for preventing and detecting fraudulent activity with respect to real estate deeds, mortgage and land trust documents by means of biometric measurements.

It is, also, a primary objective of the present invention to provide such a method for preventing and detecting fraudulent activity with respect to real estate deeds, mortgage and land trust documents by means of biometric measurements in which there is provided a unique correlation between an authenticating code imprinted, or otherwise placed, on the document being safeguarded against potential fraud, and the biometric measurement stored at a central computer representative of the unique characteristic or characteristics of the original signer of the document, in order to provide a legal seal therefor.

Toward these and other ends, the method of the present invention utilizes software to obtain a biometric measurement of the original signer to the document, and then stores it in a central computer for access at a future date when such document is presented for transaction. An authorization code or serial number that represents the stored location of the unique biometric measurement of the signer is also physically imprinted or otherwise physically placed on the actual document in order to provide on the hard copy the electronic biometric “seal” that is stored electronically by the computer. For example, the software of the present invention generates an authorization code or number representative of the stored unique biometric measurement associated with a specific document, which code is then physically placed on, or inserted into, the document evidencing the biometric seal of the user. The correlating code is unique to the document and the stored biometric seal therefor. The unique biometric measurement is “married” to the legal document to provide a “legal seal” and obviate the use of mechanical, waxed, embossed or printed seals. This biometric seal provides the guarantee to the financial institution or other party in the legal transaction that the person who has signed the document and provided a biometric measurement is indeed the actual person that he or she claims to be. The method of the invention provides for such use of biometric measurement and detection to be used in conjunction with legal documents for quick and secure authentication thereof which has heretofore not been available.

### BRIEF DESCRIPTION OF THE DRAWINGS

The invention will be more readily understood with reference to the accompanying drawings, wherein:

FIG. 1 is a block diagram showing the method of the present invention for providing a biometric-measurement seal to a real estate deed, mortgage or land trust document; and

FIG. 2 is a block diagram showing the method of the present invention for comparing the biometric-measurement seal of FIG. 1 to the person presenting the real estate deed, mortgage, land trust document claiming to be the owner or signer thereof.

### DETAILED DESCRIPTION OF THE INVENTION

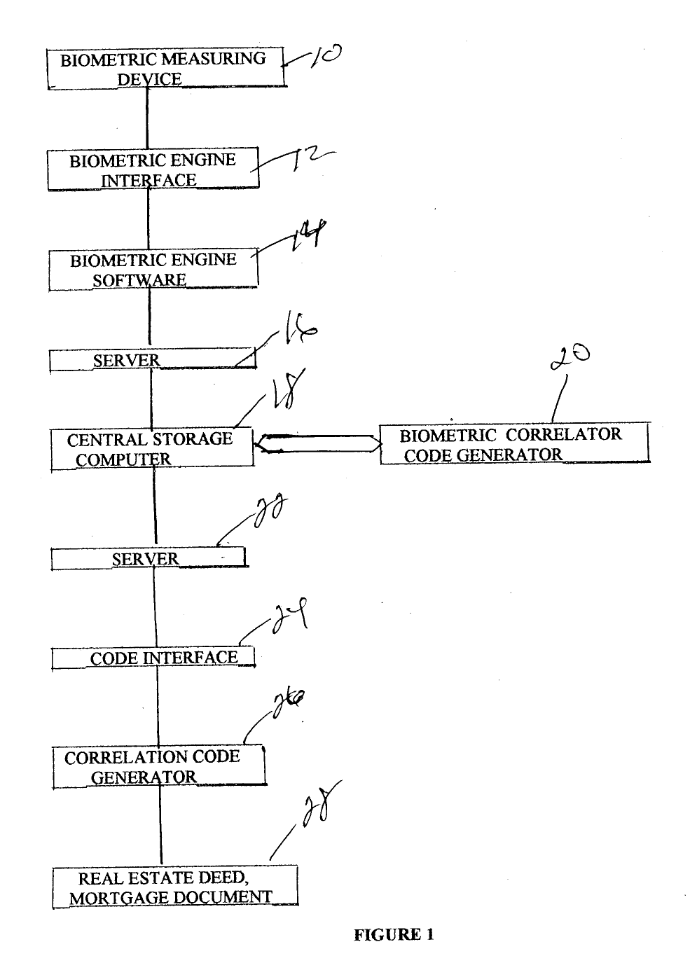

Referring to FIG. 1, there is shown the system of the invention for providing a biometric legal seal to real estate deeds, mortgages or land trust documents. The system of the invention utilizes a conventional biometric measuring device 10 for determining unique characteristics of the person signing a deed, mortgage or land trust document. The biometric measuring device 10 may use biometrics associated with fingerprint recognition, hand geometry recognition, voice recognition, retina, iris, and facial scans, and other similar uniquely defining characteristics of the person. The read or scanned data is input to a biometric engine interface 12 where the unique biometric measuring data is delivered to a biometric engine software applications program 14, where the biometric data is generated. The biometric engine software applications program 14 may be similar to the algorithm disclosed in U.S. Pat. No. 6,256,737—Bianco, et al., or another similar program where the parameters for determining threshold values are generated and calculated. This unique biometric data is then delivered to a server 16 for subsequent storage in a central computer 18. Associated with the central computer is a biometric correlator code generator 20, which generates a specific and unique code representative of the biometric measurement data received. The code generator generates a code that is unique to that signer's unique biometric measurement and the document which he signed, whereby the biometric measurement for that particular signer for the specified document is uniquely identified. The code may be a serial number, authentication number or symbol, and the like, that uniquely associates the address in the memory bank of the computer storage that stores the unique biometric measurement data with the specific document. After generating the biometric correlator code, the code is sent to server 22 for downloading to code interface applications software 24, which delivers the code data to a correlation code generator 26, which may be a printer, bar-code applicator, and the like. The correlation code generator 26 physically affixes the correlation code to the physical document 28, such as an authorization or serial number, generated by the biometric correlator code generator 20. This not only serves to uniquely and specifically identify that identity of the signature on the specific document with that document, but also serves as an electronic legal seal, in order to provide all of the legal benefits of a document provided with a valid seal.

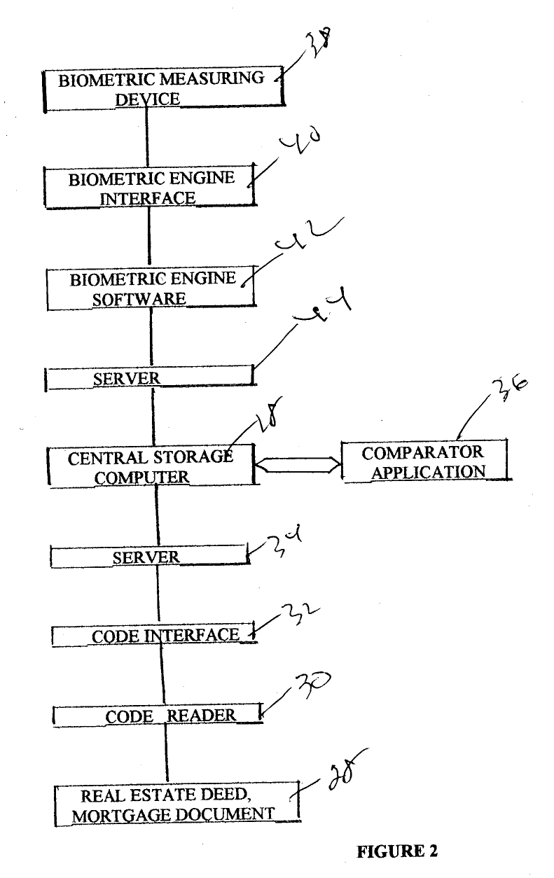

Referring now to FIG. 2, there is shown the system of the invention used for preventing fraud and for ensuring that the presenter of a real estate deed, mortgage or land trust document, or one who claims to have signed such a document, is the actual person whose signature is on the document. The document 28 may be presented to, or called up by, a bank, title or mortgage company many years after the date that the document was signed and registered with the data bank of the central computer 18 of FIG. 1. In order to ensure there is no fraud, and that the person presenting the document or claiming to have signed the document is the same person whose signature is on the document, according to the invention, the authorization or serial number, or other physical representation of biometric correlator code, is read, scanned, or otherwise detected by means of a code reader device 30. The code reader device may a simple optical scanner, bar-code scanner, and the like. In the case where the original signed document is not later presented during a transaction, such as in most real estate closing, then the authorization code need only to be entered by keyboard, or the like. The information from the reader 30, or other input device, is input to a code interface applications software 32 and sent to a server 34 for delivery to central computer 18. At the time that the authorization or serial number, or other physical representation of biometric correlator code, is read or presented, the person present is biometrically measured via biometric measuring device 38. The measured data is sent to biometric engine interface 40 and biometric engine applications software 44, similar to blocks 12 and 14 of FIG. 1. The data is sent to server 44 for delivery to the central computer 18. Conventional comparator applications software 36 compares the biometric data received from the biometric measuring device 38 with the stored biometric measuring data as represented by the biometric correlator code from blocks 28-34, or from the code otherwise input. If there is an identical match, then the system approves the transaction. If it does not find an identical match, then the transaction is rejected, indicating potential fraud. It is noted that the algorithmic criteria for determining the identical match may use one or more different biometric measurements, in a manner disclosed in U.S. Pat. No. 6,256,737—Bianco, et al.

In the case where a deed, mortgage or land trust document requires more than one signature, then all signers are biometrically measured, with the correlation code for each signer indicating multiple signers to the document. For these documents, there would effectively be multiple biometric seals for the various individuals, with concomitant corresponding multiple authorization codes which identify each biometric seal for the specific document. In addition, the system may be customized in order to allow a copy of the signature page or entire document to be scanned and stored electronically attached to a file which contains the biometric measurement data and authorization codes or codes. The information would then be stored and access would be limited to the parties to the transaction.

It may, therefore, be seen that the process of the present invention also provides that the actual, hard copy of the document contains an authorization or serial code which would enable anyone involved in a future transaction involving those documents to access the biometric data to verify that the parties involved in any further transactions relating to the specific documents match their biometric seals. For example, John Doe purchases property and “seals” the closing document using his electronic fingerprint in a biometric measuring device that scans his fingerprint and transfers it electronically to a computer along with a copy of the closing document, as described above. The software then stores the biometric fingerprint data attached to a file of the scanned closing document and issues an authorization number, as described above. The software would then issue the document specific authorization number for the biometric data and immediately send it to the parties at the transaction. The authorization number would then be physically inserted into the hard copy of the document as an electronic seal, as evidence that a biometric seal has electronically been attached to the document and is in storage on a computer, which can be accessed only by the parties to the transaction.

When John Doe sells his property, he would then have to have his fingerprint scanned again for a new set of closing documents, which could then be compared through the software to the biometric data on file from the initial transactional information. If the seals matched the identity of the John Doe, it would be confirmed and the transaction would go forward. If the biometric data did not match with the stored data, the transaction would not go through.

A person may enroll himself into the system of the present invention, if he were someone who regularly signed for large transactions, such as a real estate company executive, or high level executive. As such, the individuals biometric data would already be on file and could be checked against future transactions whenever or wherever they occurred by matching his or her biometric data with the information on file. This enrollment system would expedite transaction process, and be able to store and capture all biometric transactions in one file for the executive in a central data base. In other words, various forms of biometric data would be on a user's profile and would be stored and compared to the information provided during each subsequent transaction, as opposed to registering the individual each time the process is done.

While specific embodiments of the invention have been shown and described, it is to be understood that numerous changes and modifications may be made therein without departing from the scope and spirit of the invention as set forth in the appended claims.

What is claimed is:

1. A method of providing an electronic seal to a real estate deed, mortgage or land trust document, which document has need signed by at least one person, comprising:
(a) biometrically measuring at least one unique characteristic of the person signed on the document for generating unique identifying biometric information of the person;
(b) generating data representative of said biometric information for storing said biometric information in storage memory;
(c) storing said biometric information in storage memory for use by a computer for later access thereto;
(d) generating unique correlating code uniquely correlating said biometric information with said document;
(e) sending said unique correlating code to an output device; and
(f) placing a physical representation of said unique correlating code on said document with said output device, whereby an effective legal seal is provided thereto.

2. The method according to claim 1, wherein said output device of said step (e) is a printer, and said step (f) comprises printing a unique authentication number representative of said unique correlating code of said step (d).

3. The method according to claim 1, further comprising:
(g) biometrically measuring at least one unique characteristic of a person claiming to have signed said document of said step (a) for generating unique identifying biometric information of the person;
(h) generating data representative of said biometric information of said step (g);
(i) comparing said data representative of said biometric information of said step (h) with said data representative of said biometric information of said step (b); and
(j) determining the equality of said data representative of said biometric information of said step (h) with said data representative of said biometric information of said step (b), in order to ensure the person of said step (g) is the same as the person of said (a).

4. The method according to claim 1, wherein said step (a) comprises biometrically measuring at least one of the following unique characteristics: Fingerprint, hand geometry, retina, iris, and facial contour.

5. The method according to claim 3, wherein each of said steps (a) and (g) comprises biometrically measuring at least one of the following unique characteristics: Fingerprint, hand geometry, retina, iris, and facial contour.

6. A system for providing an electronic seal to a real estate deed, mortgage or land trust document, which document has need signed by at least one person, comprising:
first means for biometrically measuring at least one unique characteristic of the person signed on the document for generating unique identifying biometric information of the person;
second means for storing data representative of said biometric information for use by a computer;
third means for generating unique correlating code uniquely correlating said biometric information with said document;
fourth means for sending said unique correlating code to an output device; and
fifth means for receiving said unique correlating code from said fourth means for placing a physical representation of said unique correlating code on said document, whereby an effective legal seal is provided thereto.

7. The system according to claim 6, wherein said fifth means comprises a printer for printing a unique authentication number representative of said unique correlating code on said document.

8. The system according to claim 6, further comprising;
sixth means for biometrically measuring at least one unique characteristic of a person claiming to have signed said document for generating unique identifying biometric information of the person;
seventh means for generating data representative of said biometric information from said sixth means;
eighth means for comparing said data representative of said biometric information of said seventh means with said data representative of said biometric information of said first means; and
ninth means for determining the equality of said data representative of said biometric information of said seventh means with said data representative of said biometric information of said first means, in order to ensure the person measured by said seventh means is the same as the person measured by said first means.

9. The system according to claim 6, wherein said first means comprises a biometric measuring device for measuring at least one of the following unique characteristics: Fingerprint, hand geometry, voice, retina, iris, and facial contour.

10. The system according to claim 8, wherein said sixth means comprises a biometric measuring device for measuring at least one of the following unique characteristics: Fingerprint, hand geometry, voice, retina, iris, and facial contour.

11. In a method of preventing fraud in a real estate deed, mortgage or land trust document, said real estate deed, mortgage or land trust document comprising printed matter and at least one signature, said method comprising:
affixing printed matter to said real estate deed, mortgage or land trust document representing a biometric-measurement seal;
recording the biometric measurement which makes up said biometric-measurement seal, of which said printed matter is representative, in a memory device for use by a computer;
reading said printed matter representative of said biometric-measurement seal stored in said memory device;
measuring a biometric characteristic of a person; and
comparing said biometric characteristic with said biometric measurement of said step of recording;
said step of comparing comprising inputting said biometric characteristic of a person of said step of measuring and said biometric-measurement seal of said reading to a computer for performing correlational analysis therebetween.

12. The method according to claim 1 wherein said step of recording comprises at least storing said biometric measurement in storage memory associated with a computer.

13. The method according to claim 12, wherein said step of affixing printed matter comprises printing an authentication number uniquely representative of the location of said biometric measurement for said document in said storage memory.
